(19) United States
(12) Patent Application Publication
(10) Pub. No.: US 2007/0261262 A1
(43) Pub. Date: Nov. 15, 2007

(54) Drying machine

(76) Inventor: Seong Kyu Kim, Gyeongsangnam-do (KR)

Correspondence Address: BIRCH STEWART KOLASCH & BIRCH, PO BOX 747, FALLS CHURCH, VA, 22040-0747, US

(21) Appl. No.: 11/878,407

(22) Filed: Jul. 24, 2007

Related U.S. Application Data
(63) Continuation of application No. 11/034,780, filed on Jan. 14, 2005.

(30) Foreign Application Priority Data
Jul. 20, 2004 (KR) P2004-56200

(51) Int. Cl. F26B 25/00

(52) U.S. Cl. 34/88

(57) ABSTRACT

Disclosed is a drying machine including a control panel provided at a side of the drying machine and having a display hole, at least one LED lamp provided in the rear of the control panel and emitting light according to operating conditions of the drying machine, and an LED window including at least one refracting member so as to exactly display light outside through the display hole, the light emitted from the LED lamp.

### CROSS-REFERENCE TO RELATED APPLICATIONS

This is an Continuation of pending U.S. application Ser. No. 11/034,780 filed on Jan. 14, 2005, which claims the benefit of Korean Application No. P2004-56200, filed on Jul. 20, 2004, the contents of which are hereby incorporated by reference as if fully set forth herein.

### BACKGROUND OF THE INVENTION

1. Field of the Invention

The present invention relates to a drying machine, and more particularly, to a drying machine having an improved LED window.

2. Discussion of the Related Art

In general, a drying machine is an apparatus for drying laundries by using hot air generated from a heater provided therein. In recent years, a combination washer and dryer has been widely used.

The combination washer and dryer automatically dries laundries after washing is performed. A drum is rotatably provided in the dryer, and a control panel for displaying operating conditions of the dryer is provided at an upper part of the dryer.

The control panel displays operating conditions of the dryer by using light emitted from a light emitting diode lamp (LED). In this case, the light generated from the LED lamp is displayed outside through an LED window. For this reason, the LED window is provided to be exposed outside through a display hole formed at the control panel.

Meanwhile, when the light emitted from the LED lamp is directly transmitted outside through the LED window, there are problems as follows.

First, when a display hole formed at the control panel is large, the light emitted from the LED lamp diffuses penetrating through the LED window. Therefore, it is difficult for a user to distinguish which light is indicating light among a plurality of LED lamps.

Second, when the display hole is separately provided to be small, an area for displaying light outside is in itself small, the light emitted from the LED lamp. Therefore, the user is unable to recognize from which the light is emitted among a plurality of LED lamps.

### SUMMARY OF THE INVENTION

Accordingly, the present invention is directed to a drying machine that substantially obviates one or more problems due to limitations and disadvantages of the related art.

An object of the present invention is to provide a drying machine having an improved LED window.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a drying machine comprises a control panel provided at a side of the drying machine and having a display hole; at least one LED lamp provided in the rear of the control panel and emitting light according to operating conditions of the drying machine; and an LED window including at least one refracting member so as to exactly display light outside through the display hole, the light emitted from the LED lamp.

The LED window comprises a rear member provided in front of a plurality of the LED lamp and formed in a plate shape; and a front member provided on a front surface of the rear member and inserted into the display hole. The refracting member is protruded rearward from a rear surface of the LED window.

The refracting member is positioned at a position corresponding to the LED lamp. The front member is formed to have a height from the rear member.

The LED window comprises a rear member provided in front of a plurality of the LED lamp and formed in a plate shape; and at least one front member separately provided on a front surface of the rear member so as to be inserted into the display hole. The refracting member is sunken frontward from a rear surface of the LED window.

The refracting member is positioned at a position corresponding to the LED lamp. The refracting member is formed in a cylindrical shape.

In another aspect of the present invention, a drying machine comprises a control panel provided at a side of the drying machine and having a display hole formed thereat; a plurality of LED lamps provided in the rear of the control panel and emitting light according to operating conditions of the drying machine; and a plurality of refracting members each sunken frontward from each position corresponding to each of the plurality of LED lamps.

In another aspect of the present invention, a drying machine comprises a control panel provided at a side of the drying machine and having a display hole formed thereat; a plurality of LED lamps provided in the rear of the control panel and emitting light according to operating conditions of the drying machine; and an LED window comprising a rear member having a plurality of refracting members each sunken frontward from a position corresponding to each of the plurality of LED lamps, and provided in front of the plurality of LED lamps and formed in a plate shape; and at least one front member separately protruded from a front surface of the rear member so as to be inserted into the display hole.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view showing an exterior of a drying machine in accordance with the present invention;

FIG. 2 illustrates a schematic perspective view showing an inside of a control panel provided at the drying machine;

FIG. 3 illustrates a lateral view showing an LED window provided at the control panel;

FIG. 4 illustrates a perspective view showing an LED window in accordance with a first embodiment of the present invention;

FIG. 5 illustrates a cross sectional view showing the LED window in accordance with the first embodiment of the present invention;

FIG. 6 illustrates a perspective view showing an LED window in accordance with a second embodiment of the present invention; and

FIG. 7 illustrates a cross sectional view showing the LED window in accordance with the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

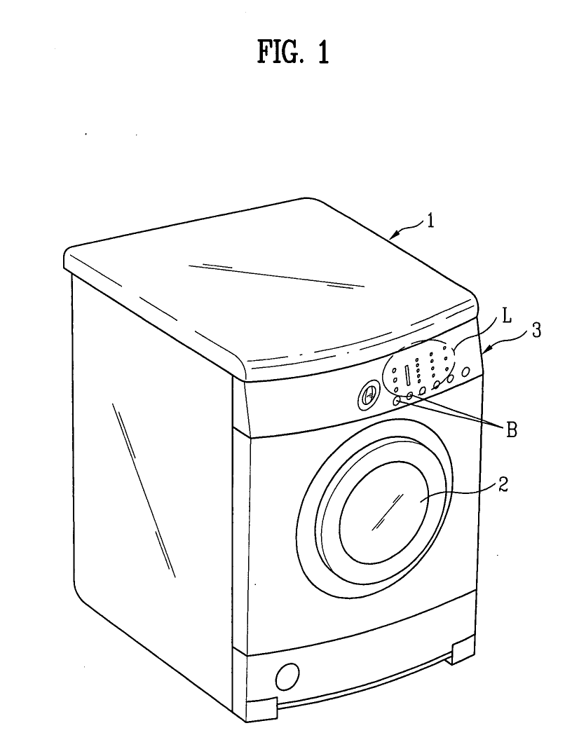

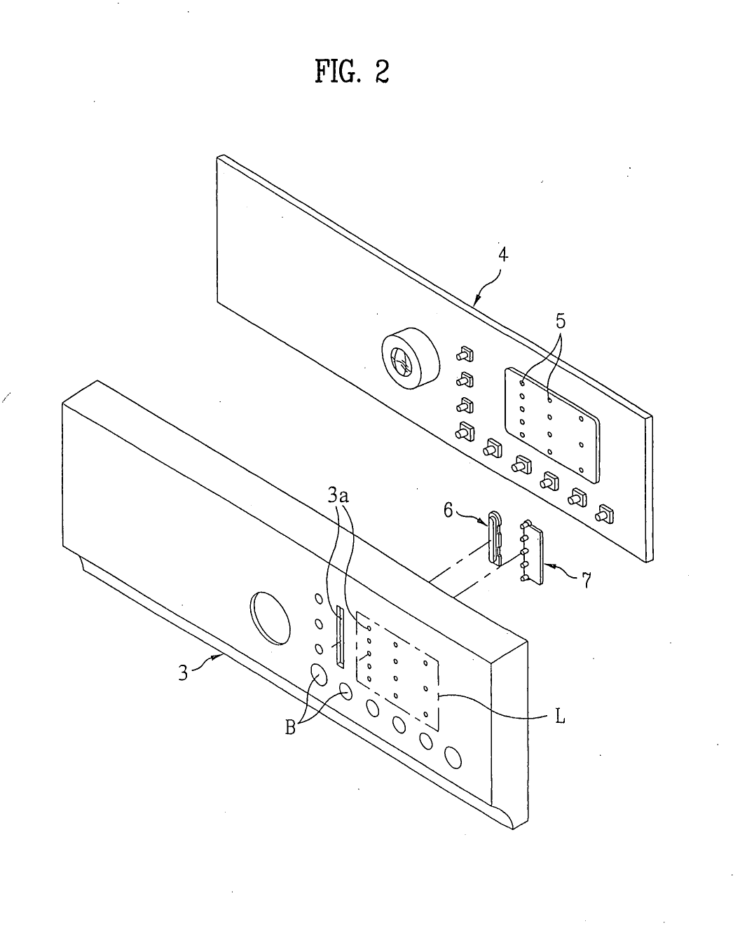

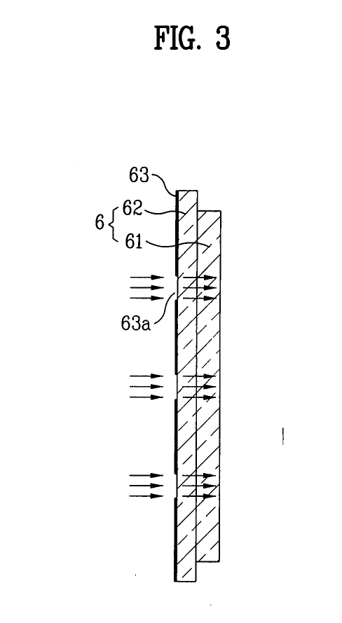

A drying machine having an LED window in accordance with a preferred embodiment of the present invention will be described as follows. FIG. 1 illustrates a perspective view showing an exterior of a drying machine in accordance with the present invention, FIG. 2 illustrates a schematic perspective view showing an inside of a control panel provided at the drying machine, and FIG. 3 illustrates a lateral view showing an LED window provided at the control panel.

As illustrated in FIG. 1, the control panel includes a control panel 3 provided at an upper part of a case 1 including the exterior thereof. In this case, a drum for accommodating laundries is rotatably provided in the case 1, and a door 2 is provided on a front surface of the case 1 so as to open/close a laundry drop which communicates with the drum.

In more detail, the control panel 3 includes a displaying member (L) for displaying operating conditions of various kinds of buttons (B) and the drying machine, the buttons for inputting a controlling command.

As illustrated in FIG. 2, a printed circuit board (PCB) 4 having various kinds of electric parts and an LED lamp 5 mounted thereon is provided in the control panel 3, and LED windows 6 and 7 are provided in front of the LED lamp 5. In this case, it is desirable that the LED windows 6 and 7 include a glass or transparent plastic material. The Led windows 6 and 7 are protruded through a display hole formed in the control panel 3, and the light emitted from the LED lamp 5 is emitted outside through the LED windows 6 and 7.

In this case, the LED window 6 and 7 are provided in various forms so as to display the operating conditions of the drying machine. For example, as illustrated in FIG. 3, a shading film 63 having three through holes 63a formed in a slot shape is provided at a rear portion of the LED window 6, the LED window 6 displaying a drying temperature by dividing the temperature into High, Medium, and Low.

A front member 61 of the LED windows 6 and 7 has a height different from that of a rear member 62 and protrudes frontward. The front member 61 of the LED window is inserted into the display hole 3a of the control panel 3 having the LED window 6 mounted thereat.

As mentioned above, the LED lamp 5 selectively emits light according to the operating conditions of the drying machine. It is desirable that a refracting member is provided at the LED window 6 so as to display the light more exactly, the light emitted from the LED lamp 5.

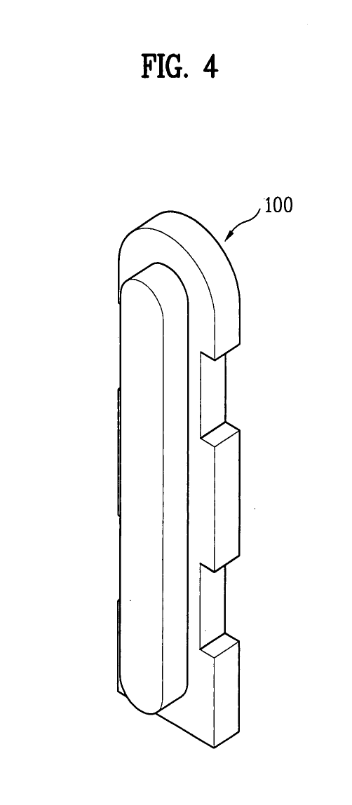

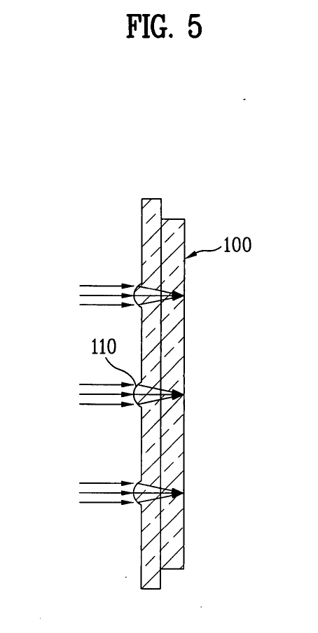

FIG. 4 illustrates a perspective view showing an LED window in accordance with a first embodiment of the present invention, and FIG. 5 illustrates a cross sectional view showing the LED window in accordance with the first embodiment of the present invention.

As illustrated in FIG. 4, the LED window 100 is formed to be long in an up-and-down direction, and has only one front member exposed outside through a display hole formed at the control panel.

When a plurality of LED lamps is provided at a rear portion of the LED window 100, the light emitted from the lamps is passed through the LED window 100 so as to diffuse. Accordingly, brightness of the light becomes weak. Therefore, it is difficult for a user to recognize the light, thereby leading the user to incorrectly read the operating conditions of the drying machine.

In order to prevent the problem, a converging refracting member is provided on a rear surface of the LED window 100 so as to converge the light emitted from the LED lamp. In other words, when an area for displaying light outside of the control panel is relatively large, the light emitted from the lamp is converged on the center so as to display the light more clearly.

As illustrated in FIG. 5, a converging refracting member 110 is protruded rearward from a rear surface of the window 100. In this case, the converging refracting member 110 is provided at a position corresponding to the position of the LED lamp provided at a rear portion of the LED window 100. The light emitted from the LED lamp is converged on the center through the converging refracting member 110, and then emitted outside. Accordingly, the light passing through the LED window 100 is converged on the center thereof and thus more clearly transmitted outside.

In this case, the area of the converging refracting member 110 is almost the same as the area through which the light of the LED lamp is displayed outside of the control panel.

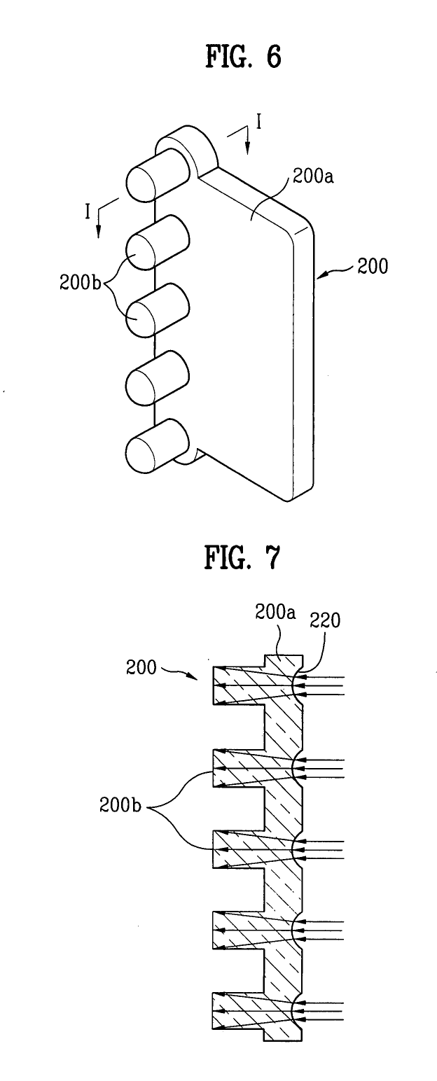

FIG. 6 illustrates a perspective view showing an LED window in accordance with a second embodiment of the present invention, and FIG. 7 illustrates a cross sectional view taken along the ling I-I of FIG. 6.

As illustrated in FIG. 6, the LED window 200 includes a rear member 200a formed in a flat plate shape, and at least one front member 200b protruded from the rear member. In this case, the at least one front member 200b is formed in a cylindrical form and each of the at least one front member 200b is separately protruded. Each of the front member 200a is provided at a position corresponding to the position of the LED lamp provided in the rear of the LED window 200.

A display hole to which the front member 200b is inserted is formed at the control panel so as to expose the front member 200b of the LED window 200. Accordingly, an end of the front member 200b is exposed outside through the display hole.

Meanwhile, since the front members 200b of the LED window 200 are spaced from each other, the area for displaying the light outside of the control panel is relatively small. In this case, since the area for displaying the light is small, the light is unnoticeable. Accordingly, the unnoticeable light emitted from the LED window 200 is diffused so as to be magnified and displayed. For this reason, a diffusing refracting member is provided at the LED window 200.

As illustrated in FIG. 7, a plurality of front member 200b spaced for a predetermined distance from each other is protruded from a front surface of the rear member of the LED window 200.

In this case, a diffusing refracting member 220 formed in a sunken form is provided on a rear surface of the front member 202b. The diffusing refracting member 220 diffuses the light to a predetermined angle from the center thereof, the light emitted from the LED lamp.

The diffusing refracting member 220 is provided at a position corresponding to the position of the LED lamp provided in the rear of the LED window 100.

It is desirable that the diameter of the diffusing refracting member 220 is formed to be almost the same as that of the display hole formed at the control panel.

As mentioned above, the light emitted from the LED lamp is diffused by the diffusing refracting member 220 and emitted outside through the front member. Accordingly, the light passing through the LED window 200 in accordance with the second embodiment is diffused outward from the center of the diffusing refracting member 220 and transmitted outside through the display hole formed at the control panel. Accordingly, since the light emitted outside is magnified and displayed, the light is easily noticed by the user.

Effects of the drying machine provided at the LED window in accordance with the present invention are as follows.

First, when the area for displaying light is large, the light emitted from the LED lamp, the light is converged on the center through the converging refracting member formed at the LED window. The LED window is also applicable to a drying machine besides a washing machine.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A drying machine comprising:
a control panel provided to the drying machine and having at least one display hole;
at least one LED provided in a rear of the control panel and emitting light according to operating conditions of the drying machine; and
an LED window including at least one refracting member configured to refract the light emitted from the LED lamp convergently or divergently so as to exactly display the light outside through the display hole.

2. The drying machine of claim 1, wherein the LED window comprises:
a rear member provided to cover a plurality of the LED lamps; and
a front member provided on a front surface of the rear member to cover the LED lamps and inserted into the display hole.

3. The drying machine of claim 1, wherein the refracting member is convexly protruded rearward from a rear surface of the LED window.

4. The drying machine of claim 3, wherein the refracting member is positioned at a position corresponding to the LED lamp.

5. The drying machine of claim 2, wherein the front member is formed to have a height from the rear member.

6. The drying machine of claim 1, wherein the LED window comprises:
a rear member provided to cover a plurality of the LED lamps; and
a plurality of front members each provided on a front surface of the rear member to cover the LED lamp and each being inserted into a corresponding display hole.

7. The drying machine of claim 1, wherein the refracting member is concavely sunken frontward from a rear surface of the LED window.

8. The drying machine of claim 7, wherein the refracting member is positioned at a position corresponding to the LED lamp.

9. The drying machine of claim 1, wherein the refracting member is formed in a cylindrical shape.

10. The drying machine of claim 1, wherein the refracting member defines a convex lens.

11. The drying machine of claim 1, wherein the refracting member defines a concave lens.

12. The drying machine of claim 1, wherein the refracting member is formed at the LED window.

13. The drying machine of claim 1, wherein the refracting member is formed at a rear surface of the LED window.

14. The drying machine of claim 1, wherein the refracting member is formed as one body with the LED window.
